(19) United States
(12) Patent Application Publication
(10) Pub. No.: US 2007/0038942 A1
(43) Pub. Date: Feb. 15, 2007

(54) Method for managing email response history

(76) Inventors: Yen-Fu Chen, Austin, TX (US); John H. Handy-Bosma, Cedar Park, TX (US); Keith R. Walker, Austin, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/189,937

(22) Filed: Jul. 26, 2005

(51) Int. Cl. G06F 17/00

(52) U.S. Cl. 715/752

(57) ABSTRACT

A method for managing email history includes receiving an email and determining whether the email includes an unembedded response history. Based on the determination, the method deletes the unembedded response history. A computer usable medium including computer readable code and a system including means for accomplishing similar actions is also disclosed.

### RELATED APPLICATIONS

This application is related to U.S. patent application Ser. No. ______(docket AUS920050417US1 9000/96) filed concurrently herewith, and the entirety of that application is incorporated herein by reference.

### FIELD OF INVENTION

The present invention generally relates to emails. More specifically, the invention relates to managing email response history.

### BACKGROUND OF THE INVENTION

Electronic communications using email are a popular method of communication between users. Many users of email send and receive megabytes worth of email—a fact that can strain network bandwidth, as well as storage.

Exacerbating the difficulties inherent in facilitating email communication is email history, especially multiple levels of history. Many email programs either automatically or by virtue of a user's setting automatically include all history in a current email chain. In an extensive chain of emails, including forwarded emails and replies, an individual email can quickly require significant bandwidth and storage for aged or dated information.

Manually deleting history can reduce this problem, but many users either do not engage in this additional effort, or do not worry about any strain on the network. Further, many users do not perceive any value gained by pruning history, and others simply do not grasp how sizable an email becomes after multiple responses. Similarly, a strict bar on including history can have unintentional and undesired effects, including potentially stifling communication while adding to a user's workload. Indeed, many users may simply not manage the response history based on the amount of time required to actively manage email response histories.

A technology that can reduce the size of emails would assist in obtaining improved system performance.

It is therefore a challenge to develop a method to parse emails to overcome these, and other, disadvantages.

### SUMMARY OF THE INVENTION

A first embodiment of the present invention is a method for managing email history that includes receiving an email and determining whether the email includes an unembedded response history. Based on the determination, the method deletes the unembedded response history.

A second embodiment of the present invention is a computer usable medium including computer readable code for managing email history that includes computer readable code for receiving an email and computer readable code for determining whether the email includes an unembedded response history. The medium includes computer readable code for deleting the unembedded response history based on the determination.

A third embodiment of the present invention is a system for managing email history that includes means for receiving an email and means for determining whether the email includes an unembedded response history. The system includes means for deleting the unembedded response history based on the determination.

The foregoing embodiment and other embodiments, objects, and aspects as well as features and advantages of the present invention will become firther apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a method for managing email response history in accordance with one aspect of the invention;

FIG. 2 illustrates another embodiment of a method for managing email response history in accordance with one aspect of the invention;

FIG. 3 illustrates another embodiment of a method for managing email response history in accordance with one aspect of the invention;

FIGS. 4A and 4B schematically illustrate embodiments of a system for managing email response history in accordance with one aspect of the invention;

FIG. 5 illustrates another embodiment of a method managing email response history in accordance with one aspect of the invention;

FIG. 6 illustrates another embodiment of a method for managing email response history in accordance with one aspect of the invention; and

FIG. 7 illustrates another embodiment of a method for managing email response history in accordance with one aspect of the invention.

### DETAILED DESCRIPTION OF THE PRESENT INVENTION

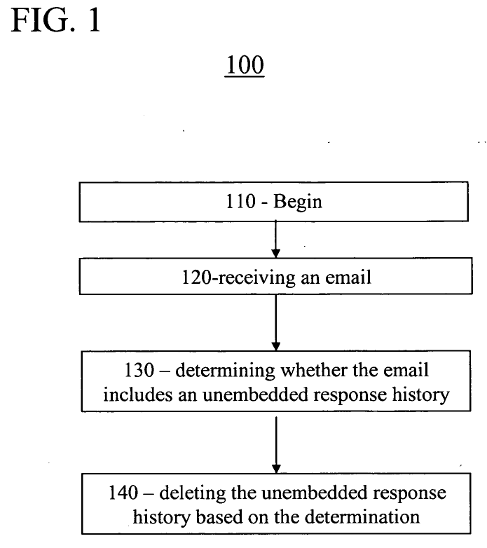

FIG. 1 illustrates one embodiment of a method 100 for managing email response history in accordance with one aspect of the invention. Method 100 begins at step 110. Any of the inventive methods disclosed herein may be performed in any order, and the order in which the method steps are described does not limit the order in which the steps can be performed.

Method 100 continues at step 120 by receiving an email. In one embodiment, the email is received at a personal computer. In another embodiment, the email is received at a mail server, either prior to delivery to at least one recipient, or prior to receipt by at least one recipient. In one embodiment, the email is received by method 100 prior to transmission from a user's personal computer as a result of a ‘send’ command. In another embodiment, the email is received by a server prior to transmission over a network but after a user submits a ‘send’. command. In another embodiment, the email is received from a public network of computers, such as the Intemet, for transmission to a user via a local, or private, network.

Having received an email, method 100 determines whether the email includes a response history at step 120. Determining whether the email includes a response history includes examining the email for factors or markers that indicate that the email includes at least one section of response history. In one embodiment, method 100 determines whether an email header includes information sufficient to identify the response history.

Method 100 determines whether the email includes an unembedded response history at step 130. In one embodiment, determining whether the email includes an unembedded response history is implemented as described in U.S. patent application Ser. No. ______(AUS920050307US1 9000/96), the entirety of which is incorporated by reference, and assigned to the assignee of this application. In one embodiment, the determination step of 130 is implemented by determining whether at least one previously exchanged email has text contained within the body of the previously sent email that was not in the body of the email when originally sent and/or received.

The unembedded response history is deleted based on the determination at step 140. Deleting the unembedded response history relates to removing the textual content of the unembededded response history from the email being sent or received. Additional methods relating to embodiments of a method for deleting unembedded response history are outlined below.

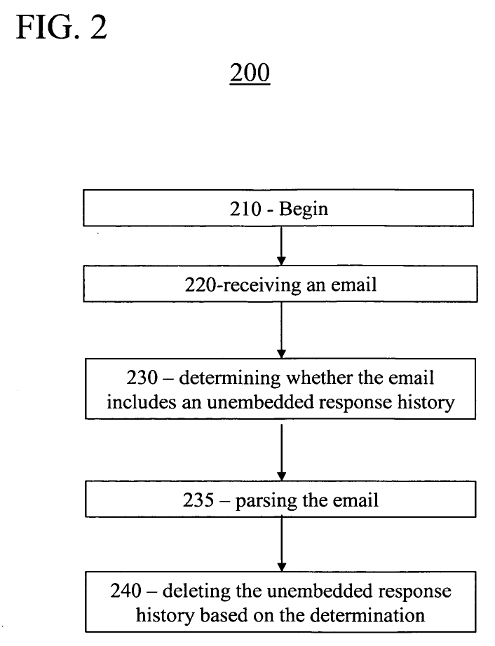

FIG. 2 illustrates another embodiment of a method 200 for managing email response history in accordance with one aspect of the invention. Method 200 begins at step 210. An email is received at step 220. In one embodiment, step 220 is implemented as in step 120. Method 200 determines whether the email includes an unembedded response history at step 230. In one embodiment, step 230 is implemented as in step 130.

Having determined that the email includes an unembedded response history, method 200 parses the email at step 235. Parsing the email, in one embodiment, includes identifying and/or labeling each response history with a response history level, and identifying and/or labeling the unembedded response history.

Having parsed the email, method 200 then deletes the unembedded response history at step 240. Deleting the unembedded response history, in one embodiment, includes removing the characters that collectively define the unembedded response history. In another embodiment, the unembedded response history is replaced with text indicative of the removal or deletion of the unembedded response history. The replacement text can include additional information, such as the identity of the entity that removed the response history, the time, whether the response history has been saved and if so the save location, whether deletion of the response history was automatic or manual, or similar information.

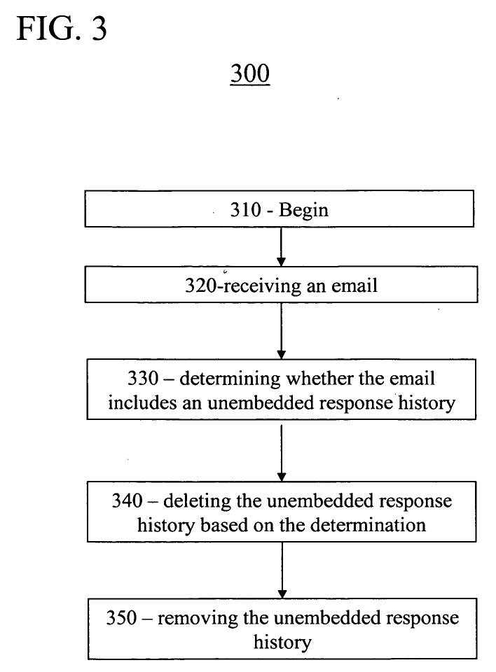

FIG. 3 illustrates another embodiment of a method 300 for managing email response history in accordance with one aspect of the invention. Method 300 begins at step 310. An email is received at step 320. In one embodiment, step 320 is implemented as in step 120. Method 300 determnines whether the email includes an unembedded response history at step 330. In one embodiment, step 330 is implemented as in step 130. At step 340, method 300 deletes the unembedded response history based on the determination. In one embodiment, step 340 is implemented as step 240.

At step 350, method 300 removes the unembedded response history. Removing the unembedded response history, in one embodiment, includes a full deletion of the history. In another embodiment, removing the unembedded response history includes hiding the unembedded response history form a display of the email, while maintaining the unembedded response history in a memory or in a stored version of the email.

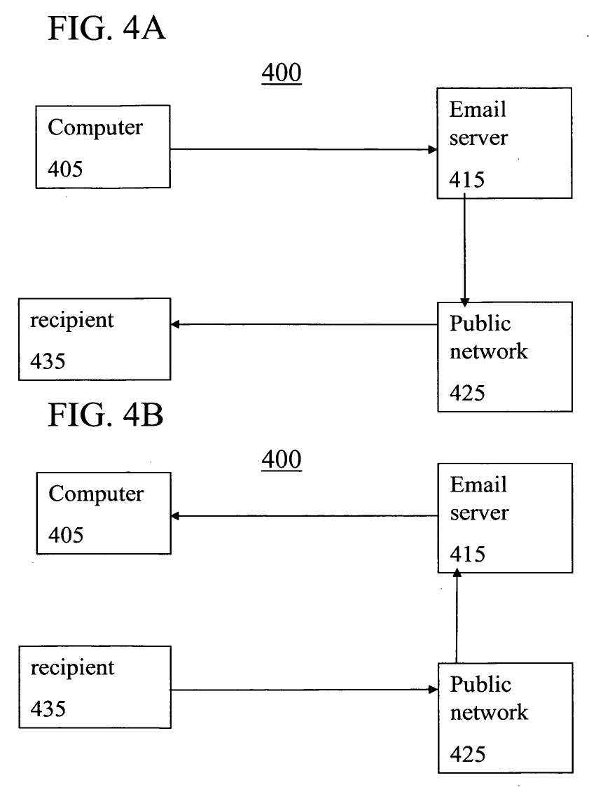

FIGS. 4A and 4B schematically illustrate two locations that can remove the unembedded response history in accordance with the invention. FIG. 4A, at 400, shows personal computer 405 sending an email to email server 415. From email server 415, the email is transmitted to a public network 425, such as the Intemet. From the public network 425, the email is transmitted to a recipient 435. Recipient 435 may be an email server, or a personal computer. As show at 400, methods in accordance with the invention herein, such as methods 100, 200, 300, 500, and 600 can variously be implemented at personal computer 405, email server 415, or recipient 435. FIG. 4B illustrates an email returning to the original personal computer 405. As shown in FIG. 4B, any of the inventive methods herein can be implemented at personal computer 405, email server 415, or recipient 435. The unembedded response history, in one embodiment, is removed prior to transmission from a local network, such as email server 415, to a public network, such as network 425. Alternatively, in another embodiment, the unembedded response history is removed prior to transmission from a local network, such as email server 415, to a personal computer, such as personal computer 405.

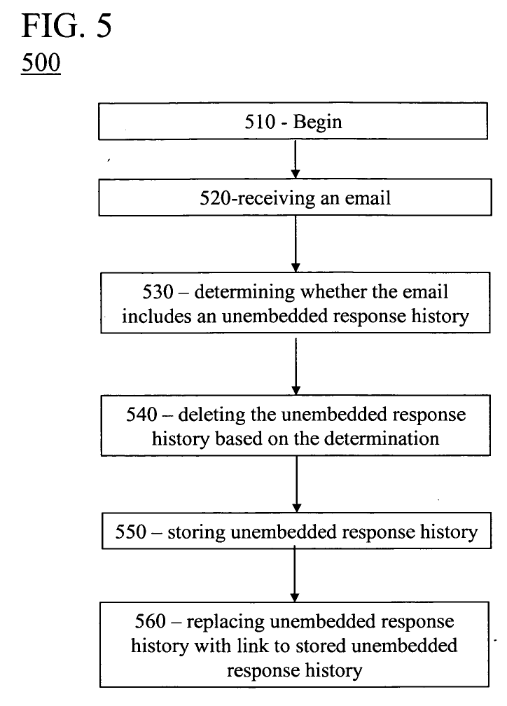

FIG. 5 illustrates another embodiment of a method 500 for managing email response history in accordance with one aspect of the invention. Method 500 begins at step 510. An email is received at step 520. In one embodiment, step 520 is implemented as in step 120. Method 500 determines whether the email includes an unembedded response history at step 530. In one embodiment, step 530 is implemented as in step 130.

At step 540, method 500 deletes the unembedded response history based on the determination. In one embodiment, step 540 is implemented as step 240.

In method 500, deleting the unembedded response history includes storing the unembedded response history at step 550 and replacing the deleted unembedded response history with a link to the stored unembedded response history at step 560. The unembedded response history can be stored at any location in communication with the device that deleted the unembedded response history. For example, and with reference to FIGS. 4A and 4B, the unembedded response history can be stored at personal computer 405, email server 415 or recipient 435. In another example, the unembedded response history is stored at a location other than those illustrated in FIGS. 4A and 4B, or at a location in communication with at least one of the devices illustrated in FIGS. 4A and 4B. The unembedded response history can be stored and transmitted along with the email in one embodiment The link provided in step 560 can be inserted directly into the email, and link to the location where the unembedded response history is stored. The link can be a HTML link or other similar markup language link. The link, in another embodiment, includes a text string indicative of a file location, but does not include a markup language feature enabling access to the stored embedded response history via a predetermined number of mouse clicks.

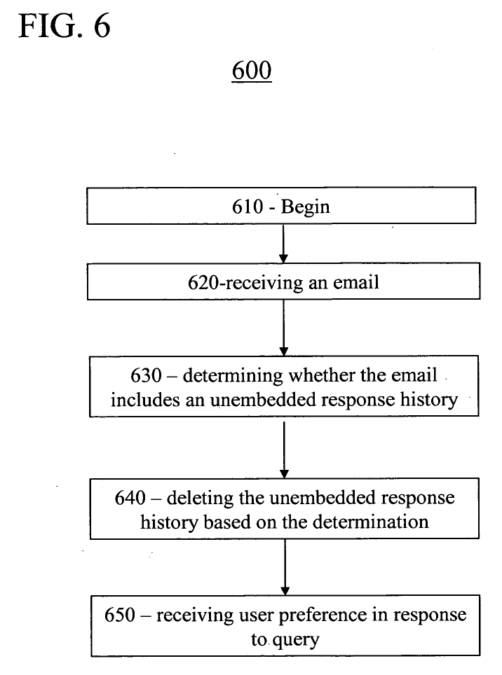

FIG. 6 illustrates another embodiment of a method 600 for managing email response history in accordance with one aspect of the invention. Method 600 begins at step 610. An email is received at step 620. In one embodiment, step 620 is implemented as in step 120. Method 600 determines whether the email includes an unembedded response history at step 630. In one embodiment, step 630 is implemented as in step 130. Method 600 deletes the unembedded response history at step 640. In one embodiment, step 640 is implemented as in step 240.

In method 600, deleting the unembedded response history further includes receiving a user preference in response to a query at step 650. By offering a user the opportunity to provide a preference, method 600 provides user-customizable email history management. For example, a user may prefer to activate automatic response history deletion of all levels, or any levels older than n number of levels. In another embodiment, the method processes t−n=y levels of response history, where t=total number of levels (such as determined in accordance with U.S. patent application Ser. No. 11/______, incorporated herein by reference), n is the user defined number of levels of response history to process andy is the number of levels to process. In another example, a user can indicate on an email-specific basis, the precise instances of response history to delete or not delete.

A query under step 650 can include any number of queries to configure email history. For example, the query can request a response to at least one question designed to elicit user preferences. For example, the user can reply with partial history or automatically purge or delete unembedded response history without confirmation or with confirmation. Further, the query can be provided using a text window, or a GUI interface. The GUI menu can provide at least one option, or any number of options. The user can elect to engage automatic unembedded response history management when composing email, or engage automatic unembedded response history management when receiving incoming email, in some embodiments. Further, the user can elect to establish, or modify a default, a number of unembedded response histories to manage.

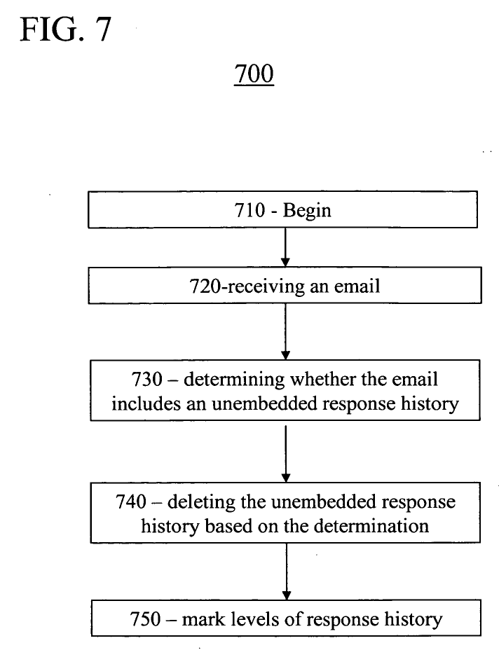

FIG. 7 illustrates another embodiment of a method 700 for managing email response history in accordance with one aspect of the invention. Method 700 begins at step 710. An email is received at step 720. In one embodiment, step 720 is implemented as in step 120. Method 700 determines whether the email includes an unembedded response history at step 730. In one embodiment, step 730 is implemented as in step 130. Method 700 deletes the unembedded response history at step 740. In one embodiment, step 740 is implemented as in step 240.

Each level of response history is marked at step 750. Marking each section allows a user to manage their email history with mouse clicks. Marking the email, in accordance with the invention, can include any strategy. For example, each level of response history can be collapsed into a visible section. In some embodiments, the collapsed history is indicated by an icon indicative of hidden information. In another embodiment, marking is implemented by making at least one section of response history ‘right-clickable’ to manually designate a start and end of each response history section. Marking can include the addition of color, or other graphical indicator such as flashing, to the email to set each response history section apart from the other response history sections. In another embodiment, distinct lines are displayed between each response history section.

In another embodiment, a user can merge at least two sections of response history. In one embodiment, merging sections manually creates an embedded response history. In one embodiment, dragging the response history section merges, or embeds, the response history section with the targeted response history sections.

The teachings and disclosures of this invention can be implemented in any email format. Such formats includes, but are not limited to, POP3, IMAP, MAPI, Lotus Domino, Lotus Notes, and the like. Furthermore, the methods disclosed herein can be applied to a single email, or executed as a batch file that operates on a plurality of emails sequentially.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of managing email history comprising:
receiving an email;
determining whether the email includes an unembedded response history; and
deleting the unembedded response history based on the determination.

2. The method of claim 1 wherein determining whether the email includes an unembedded response history comprises parsing the email.

3. The method of claim 1 wherein deleting the unembedded response history based on the determination comprises removing the unembedded response history from the email.

4. The method of claim 3 wherein the unembedded response history from the email is removed prior to transmission from a local network to a public network.

5. The method of claim 3 wherein the unembedded response history from the email is removed prior to transmission from a local network to a personal computer.

6. The method of claim 1 wherein deleting the unembedded response history based on the determination comprises:
storing the unembedded response history; and
replacing the unembedded response history with a link to the stored unembedded response history.

7. The method of claim 1 wherein deleting the unembedded response history based on the determination comprises receiving a user preference in response to a query to manage the unembedded response history.

8. The method of claim 7 wherein the query requests a response to at least one of the queries selected from the group consisting of reply with partial history, automatically purge unembedded response history with confirmation, automatically purge unembedded response history without confirmation, a GUI menu providing at least one option, engage automatic unembedded response history management on composing email, engage automatic unembedded response history management on incoming email, and establishing a number of unembedded response histories to manage.

9. A computer usable medium including computer readable code for managing email history comprising:
computer readable code for receiving an email;
computer readable code for determining whether the email includes an unembedded response history; and
computer readable code for deleting the unembedded response history based on the determination.

10. The medium of claim 9 wherein computer readable code for determining whether the email includes an unembedded response history comprises computer readable code for parsing the email.

11. The medium of claim 9 wherein computer readable code for deleting the unembedded response history based on the determination comprises computer readable code for removing the unembedded response history from the email.

12. The medium of claim 11 wherein the unembedded response history from the email is removed prior to transmission from a local network to a public network.

13. The medium of claim 11 wherein the unembedded response history from the email is removed prior to transmission from a local network to a personal computer.

14. The medium of claim 9 wherein computer readable code for deleting the unembedded response history based on the determination comprises:
computer readable code for storing the unembedded response history; and
computer readable code for replacing the unembedded response history with a link to the stored unembedded response history.

15. The medium of claim 9 wherein computer readable code for deleting the unembedded response history based on the determination comprises computer readable code for receiving a user preference in response to a query to manage the unembedded response history.

16. The medium of claim 15 wherein the query requests a response to at least one of the queries selected from the group consisting of reply with partial history, automatically purge unembedded response history with confirmation, automatically purge unembedded response history without confirmation, a GUI menu providing at least one option, engage automatic unembedded response history management on composing email, engage automatic unembedded response history management on incoming email, and establishing a number of unembedded response histories to manage.

17. A system for managing email history comprising:
means for receiving an email;
means for determining whether the email includes an unembedded response history; and
means for deleting the unembedded response history based on the determination.
